(19) United States
(12) Patent Application Publication
(10) Pub. No.: US 2026/0072970 A1
(43) Pub. Date: Mar. 12, 2026

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Yohei TAKATSUKA, Kanagawa (JP); Hirofumi MIYATA, Kanagawa (JP)

(73) Assignee: FUJIFILM Business Innovation Corp., Tokyo (JP)

(21) Appl. No.: 19/064,653

(22) Filed: Feb. 26, 2025

(30) Foreign Application Priority Data
Sep. 12, 2024 (JP) 2024-157978

(51) Int. Cl. G06F 16/338; G06F 3/04842; G06F 16/335; H04L 51/08

(52) U.S. Cl. CPC G06F 16/338; G06F 3/04842; G06F 16/335; H04L 51/08

(57) ABSTRACT

An information processing system includes a processor configured to receive a comment input by a user on a document, select a related document based on the document and the comment, and present the selected related document.

### CROSS-REFERENCE TO RELATED APPLICATIONS

This application is based on and claims priority under 35 USC 119 from Japanese Patent Application No. 2024-157978 filed Sep. 12, 2024.

### BACKGROUND

### (i) Technical Field

The present invention relates to an information processing system, a non-transitory computer readable medium storing a program, and an information processing method.

### (ii) Related Art

In a case in which a document is being created or viewed, there may be a case in which a document related to the document is to be referred to or a case in which another user is to be notified. For example, it is efficient to be able to present a document created in the same project as the specification to other project members while viewing the specification.

In the related art, in a document (hereinafter, a “related document”) related to a document being viewed (hereinafter, a “viewing document”), the related document of the viewing document is extracted by, for example, extracting a feature word in the viewing document and searching for the word as a keyword from among documents in a document group. Alternatively, each document included in the document group is converted into a vector representation based on the content and stored. The content of the viewing document is also converted into a vector representation, and a document close to the vector representation of the stored document group that is a search source is extracted as the related document of the viewing document.

JP2008-276594A proposes a technique of automatically searching for and displaying a document appropriate for a phase in a process (step) of work of a user, based on a phase in which the user is currently located.

### SUMMARY

Meanwhile, for example, in a document application having a function of adding a comment to the document, the comment input by the user can be added to the document. The user may use this function to input the comment for the entire document or a part of the described contents. That is, the comment may include a word related to the content of the document, a word indicating a feature of the document, an expression indicating a viewpoint in a case of confirming the content, a quality, or an error of the document, and the like.

However, in the related art, a word for searching for the related document is extracted from a document that is a related document presentation target, but is not extracted from the comment on the document.

Aspects of non-limiting embodiments of the present disclosure relate to an information processing system, a non-transitory computer readable medium storing a program, and an information processing method that present a related document related to a document by referring to contents of each of the document and a comment on the document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: receive a comment input by a user on a document; select a related document based on the document and the comment; and present the selected related document.

### BRIEF DESCRIPTION OF THE DRAWINGS

Exemplary embodiment(s) of the present invention will be described in detail based on the following figures, wherein:

FIG. 1 is a block configuration diagram showing an information processing apparatus in Exemplary Embodiment 1;

FIG. 2 is a diagram showing an example of a data structure of important word information in Exemplary Embodiment 1;

FIG. 3 is a flowchart showing document processing in Exemplary Embodiment 1;

FIG. 4 is a diagram showing an example of screen display of a window for document processing in Exemplary Embodiment 1;

FIG. 5 is a diagram showing a data setting example of the important word information at the time of new creation in Exemplary Embodiment 1;

FIG. 6 is a flowchart showing important word information update processing according to Exemplary Embodiment 1;

FIG. 7 is a diagram showing an example of screen display of the window for document processing in a case in which a related document list is additionally displayed in Exemplary Embodiment 1;

FIG. 8 is a diagram used to describe a user operation of selecting a related document from the related document list displayed in the window for document processing shown in FIG. 7;

FIG. 9 is a diagram showing an example of screen display after the related document is selected by a user from the related document list displayed in the window for document processing shown in FIG. 7;

FIG. 10 is a diagram showing an example of display of an initial screen of a window for recommended document selection in Exemplary Embodiment 2;

FIG. 11 is a diagram showing an example of screen display of THE window for recommended document selection in a case in which a recommended document is selected in FIG. 10;

FIG. 12A is a diagram showing a comment input in a comment input field in Exemplary Embodiment 3, and FIG. 12B is a diagram showing a relationship with a related document list displayed based on a comment in a window for recommended document selection;

FIGS. 13A and 13B are diagrams following FIGS. 12A and 12B, in which FIG. 13A is a diagram showing the comment input in the comment input field, and FIG. 13B is a diagram showing a relationship with the related document list displayed based on the comment in the window for recommended document selection;

FIGS. 14A and 14B are diagrams following FIGS. 13A and 13B, in which FIG. 14A is a diagram showing the comment input in the comment input field, and FIG. 14B is a diagram showing a relationship with the related document list displayed based on the comment in the window for recommended document selection;

FIG. 15 is a diagram showing an example of screen display of a window for document processing and a window for recommended document selection in Exemplary Embodiment 4;

FIG. 16 is a diagram showing an example of screen display of a window for document processing and a window for recommended document selection in Exemplary Embodiment 5;

FIG. 17 is a diagram showing an example of screen display of a window for document processing in Exemplary Embodiment 6;

FIG. 18 is a diagram showing an example of a reply email screen displayed in a window displayed by a mailer in Exemplary Embodiment 7; and

FIG. 19 is a diagram showing an example of a reply email screen after a related document is selected by a user in Exemplary Embodiment 7.

### DETAILED DESCRIPTION

Hereinafter, exemplary embodiments of the present invention will be described with reference to the accompanying drawings.

### Exemplary Embodiment 1

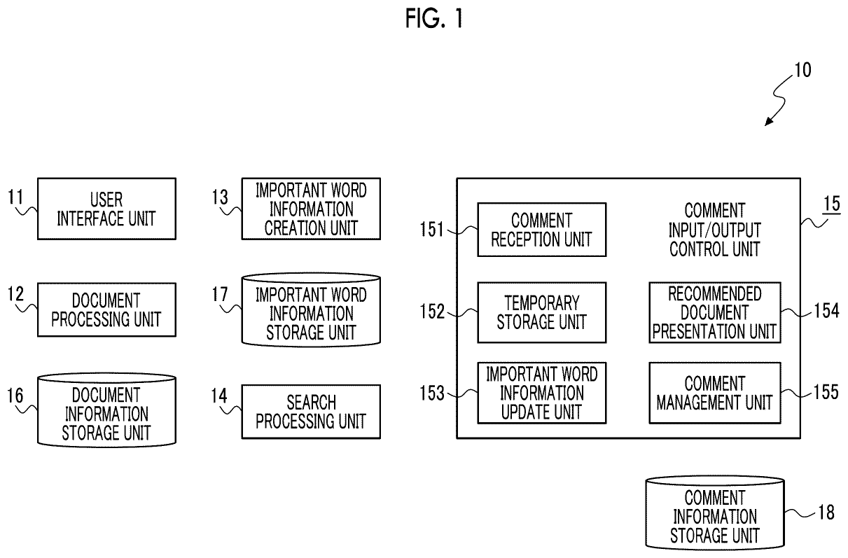

FIG. 1 is a block configuration diagram showing an information processing apparatus 10 according to the present exemplary embodiment. The information processing apparatus 10 is one exemplary embodiment of an information processing system according to the exemplary embodiment of the present invention.

The information processing apparatus 10 according to the present exemplary embodiment can be implemented by the existing general-purpose hardware configuration, such as a personal computer (PC). That is, the information processing apparatus 10 includes a processor, a ROM, a RAM, a hard disk drive (HDD) as a storage unit, a network interface (IF) provided as a communication unit, and a user interface including an input unit such as a mouse or a keyboard and a display unit such as a display.

As shown in FIG. 1, the information processing apparatus 10 according to the present exemplary embodiment includes a user interface unit 11, a document processing unit 12, an important word information creation unit 13, a search processing unit 14, a comment input/output control unit 15, a document information storage unit 16, an important word information storage unit 17, and a comment information storage unit 18. The component not used in the description of the present exemplary embodiment is not shown in FIG. 1.

The user interface unit 11 receives user input and displays information. The document processing unit 12 is implemented by executing a document application, and executes document processing such as creation, display, change, and deletion of a document. In particular, the document handled in the present exemplary embodiment is a target to which a comment is added and is an extraction source of an important word. The important word information creation unit 13 creates important word information in the document selected as a viewing target by a user. The important word information is created for each document. The details of the important word information will be described below. The search processing unit 14 searches for the document using the important word included in the important word information as the keyword. The comment input/output control unit 15 controls the input and output of the comment input by the user to the document being viewed.

The comment input/output control unit 15 includes a comment reception unit 151, a temporary storage unit 152, an important word information update unit 153, a recommended document presentation unit 154, and a comment management unit 155. The comment reception unit 151 receives the comment input by the user. The temporary storage unit 152 temporarily stores the received comment. The important word information update unit 153 updates the important word information corresponding to the document in response to the comment input to the document being viewed. The recommended document presentation unit 154 presents a recommended document to the user based on the document searched by the search processing unit 14. The comment management unit 155 manages the comment input by the user by registering the comment in the comment information storage unit 18 or the like.

Since the comment input/output control unit 15, the important word information creation unit 13, and the search processing unit 14 also perform processing on the document, the components 13 to 15 may be included in the document processing unit 12. However, as will be clear from the following description, the comment input/output control unit 15 and the important word information creation unit 13 are provided separately from the document processing unit 12 in order to implement additional functions that are characteristic in the present exemplary embodiment.

The document information storage unit 16 stores information (hereinafter, also referred to as “document information”) related to the document to be handled in the present exemplary embodiment. In the present exemplary embodiment, as the documents, a document that is a viewing target and a document related to the document and to be presented to the user as a related document are handled, and information related to both documents is stored in the document information storage unit 16. In the document information, a document name, a creation of the document, a creation date of the document, and storage destination information of the document are associated with a document ID as information for identifying the document. Further, the document body stored in the information processing apparatus 10 may be stored as necessary.

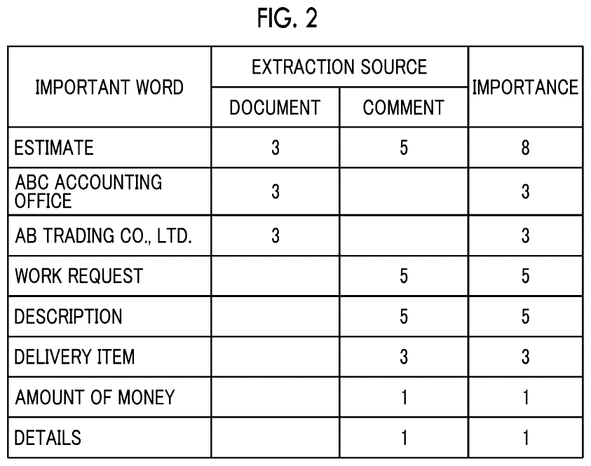

The important word information storage unit 17 stores the important word information. FIG. 2 shows an example of a data structure of the important word information in the present exemplary embodiment.

The important word information is created for each document and includes one or a plurality of important words extracted from the document and the comment input by the user on the document. The important word is a word recognized as a word indicating features of the document and the comment (so-called “feature word”) in a sentence constituting the document and the comment. Therefore, in the present exemplary embodiment, a word to be extracted as the important word and a word to be extracted as the feature word are the same word. In other words, the important word and the feature word are synonymous. The importance of the important word indicating a level of importance of the important word is associated with the important word. In the present exemplary embodiment, as a numerical value of the importance is larger, the word is more important. The importance is stored for each extraction source of the important word, that is, the importance is stored to be distinguishable whether the important word is extracted from the document or the comment. The importance of the important word is indicated by a total value of the importance in the document and the importance in the comment. The importance is referred to in a case of extracting the related document from a document group of which information is managed by using the document information storage unit 16 and in a case of determining a display order of the extracted related documents.

In the present exemplary embodiment, the feature word extracted by using a method of extracting a feature word such as term frequency-inverse document frequency (TF-JDF), a support-vector machine (SVM), or KeyGraph is treated as the important word. In the present exemplary embodiment, the importance is set to a “word” meaning a term, but may be set to a text string including a phrase, that is, a so-called words and phrases.

The comment information storage unit 18 stores information (hereinafter, also referred to as “comment information”) related to the comment input by the user. The comment information is created by associating the document ID of the document to which the comment is added, time information for specifying an input date and time of the comment, the related document searched and selected from the comment by the search processing unit 14, and information for determining whether or not the related document is selected as the recommended document by the user with a comment ID for identifying the comment.

Each of the components 11 to 15 of the information processing apparatus 10 is implemented by a cooperative operation of a computer that constitutes the information processing apparatus 10 and a program that is operated by the processor provided in the computer. In addition, each of the storage units 16 to 18 is implemented by the HDD mounted on the information processing apparatus 10. Alternatively, a RAM or an external storage unit may be used via a network.

Hereinafter, an operation of the present exemplary embodiment will be described.

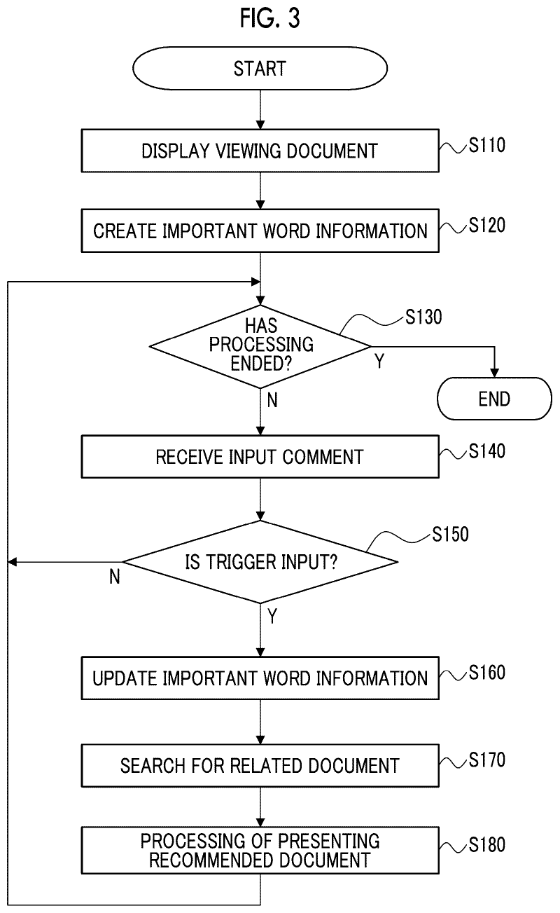

In the present exemplary embodiment, in a case in which the comment is added to the document being viewed, a document related to the document (hereinafter, also referred to as a “related document”) is selected based on the document and the comment, and the selected related document is displayed in association with the comment, to present the related document to the user. The document processing in the present exemplary embodiment will be described with reference to the flowchart shown in FIG. 3.

The information processing apparatus 10 starts the operation in the document processing unit 12 by starting the document application in response to a user operation. In a case in which the document processing unit 12 is started and the document is selected by the user, the document selected by the user is displayed in a window displayed on a display (step S110). The user inputs a desired comment to the document while viewing the displayed document.

The document processing unit 12 displays the document on the user interface unit 11, and the comment input/output control unit 15 receives the comment received by the user interface unit 11, but, hereinafter, the description will be made without describing the operation in the user interface unit 11.

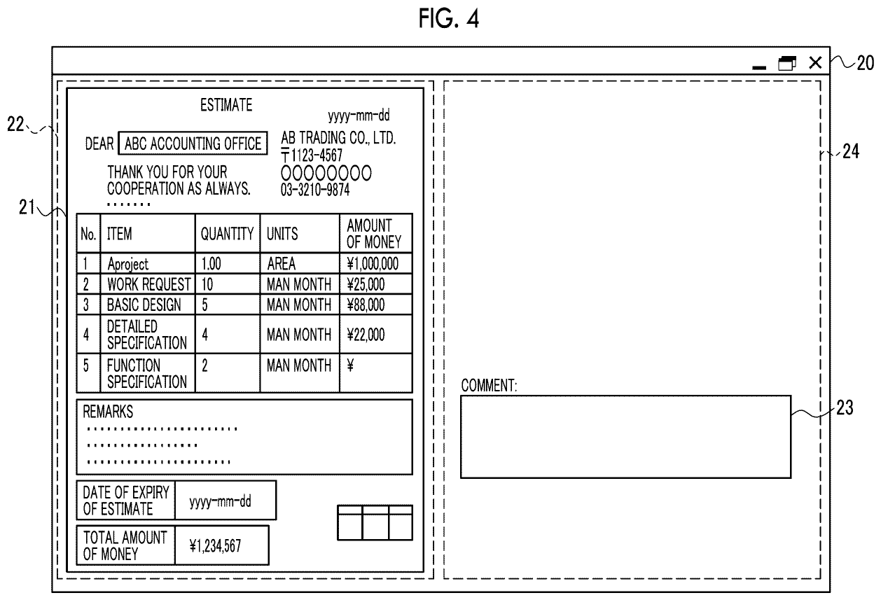

FIG. 4 is a diagram showing an example of screen display of a window for document processing 20 in which the document is displayed and the comment is input by the user in the present exemplary embodiment. The window for document processing 20 includes a document display region 22 that displays the content of a document (hereinafter, also referred to as a “viewing document”) 21 selected by the user as the viewing target, and a comment display region 24 including a comment input field 23 corresponding to a comment input region in which the comment is input by the user.

The layout in the window for document processing 20 shown in FIG. 4 is an example, and the present invention is not limited thereto. For example, in FIG. 4, the comment display region 24 is provided on a right side of the document display region 22, but a positional relationship between the display regions 22 and 24 is not limited to this. In addition, the sizes of the regions 22 and 24 may also be any size and may be changeable.

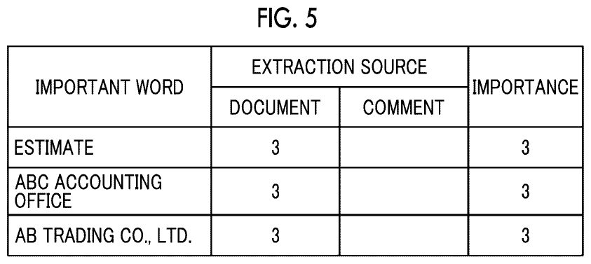

In a case in which the document 21 is selected by the user and is displayed on the screen, the important word information creation unit 13 creates the important word information corresponding to the document 21 (step S120). That is, the important word information creation unit 13 extracts the feature word by analyzing the document 21, treats the extracted feature word as the important word, and sets the extracted feature word as the “important word” in the important word information shown in FIG. 2. Then, an initial value (for example, 3) of the important word in the document is set in a field of “document” of the extraction source for each registered important word. For the “importance”, the total value of the importance of the document and the importance of the comment is calculated and set. FIG. 5 shows a data structure example of the important word information at the time of new creation.

The important word information creation unit 13 registers the important word information created as described above in the important word information storage unit 17, in association with the document ID of the document.

In FIGS. 2 and 5, a blank field means that the important word is not extracted from the document or the comment. In a case of calculating the total value of the importance, the numerical value is equal to 0. In addition, the “important word” set in the important word information is merely an example of a word.

Thereafter, the information processing apparatus 10 ends the document processing in response to an end instruction from the user (Y in step S130), but the information processing apparatus 10 executes processing described below until the end instruction is issued (N in step S130).

The user views the document 21 displayed in the document display region 22 and inputs the comment on the document 21 to the comment input field 23 as necessary. The comment reception unit 151 receives the comment input by the user (step S140). The information processing apparatus 10 executes processing of receiving the comment until a predetermined trigger is input (N in step S150).

The comment input/output control unit 15 stores the comment received by the comment reception unit 151 in the temporary storage unit 152. In the present exemplary embodiment, the temporary storage unit 152 is provided in the comment input/output control unit 15. That is, an application for implementing the comment input/output control unit 15 is loaded in the RAM, so that the temporary storage unit 152 is also formed in the RAM. However, the temporary storage unit 152 may be provided outside the comment input/output control unit 15, such as the HDD.

The comment management unit 155 creates the comment information related to the comment stored in the temporary storage unit 152 in response to the input of the predetermined trigger, and registers and manages the comment information in the comment information storage unit 18. Here, the “predetermined trigger” is a trigger for performing processing of presenting the related document to the user. For example, a case in which a predetermined symbol such as “/” is input to the comment or a case in which a specific phrase such as a comma is input is used as the trigger. Alternatively, a case in which the number of consecutively input texts as the comments is N (N is a natural number) or more, or a case in which a non-input state during the input of the comment continues for T (T is a natural number) seconds may be used as the trigger even though a symbol or a punctuation mark is not input.

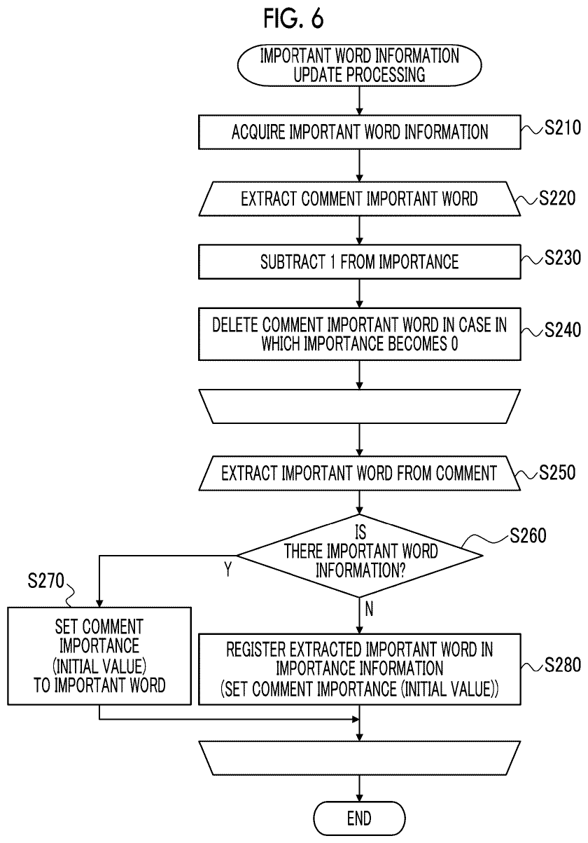

In a case in which the above-described trigger is input (Y in step S150), the important word information update unit 153 updates the important word information created corresponding to the document 21 (step S160). The processing of updating the important word information will be described with reference to the flowchart shown in FIG. 6.

The important word information update unit 153 first reads and acquires the important word information corresponding to the document 21 from the important word information storage unit 17 (step S210). The important word information includes an important word extracted from the document and an important word extracted from the comment, as shown in FIG. 2. The important word information update unit 153 extracts the important word extracted from the comment from the important word information (step S220). In the following description, the important word extracted from the comment will be described as a “comment important word” in particular.

In FIG. 2, the importance is set for both the document and the comment in the important word “estimate”. This means that the “estimate” is extracted from both the document and the comment. Therefore, the “estimate” corresponds to the comment important word. By assuming a case in which the important word is extracted from both the document and the comment as in the “estimate”, and flag information for distinguishing whether the important word is newly set and registered in the document or the comment may be added to a table of the important word information.

The important word information update unit 153 then performs processing described below on each of the extracted comment important words. That is, the important word information update unit 153 performs subtraction from the importance in the comment important word. Here, for example, 1 is subtracted. The importance of the comment important word may become 0 due to the subtraction, but the comment important word having the importance of 0 is deleted from the important word information (step S240). The deletion target is the comment important word of which the extraction source is the comment. That is, in the comment important word of which the extraction source is the document, the comment important word is not deleted even though the importance of the comment important word becomes 0.

As described above, in a case in which the processing on the comment important word already included in the important word information ends, the important word information update unit 153 extracts the feature word from the comment as the important word in the same manner as the processing in the important word information creation unit 13 (step S250). The important word information update unit 153 performs processing described below on each important word extracted from the comment. That is, in a case in which the extracted important word is not present in the important word information (N in step S260), the important word information update unit 153 newly sets the important word in the important word information, and sets the initial value (for example, 5) of the importance of the comment for the important word in the comment field of the extraction source in the important word information (step S280).

In FIG. 2, since the importance of the “work request” and the “description” in a case in which the extraction source is the document is blank (that is, 0), it can be recognized that the important word is the important word extracted from the comment, but, since the importance is 5, it can be seen that the important word is a new important word set at this time. Although “delivery item”, “amount of money”, and “details” are also important words extracted from the comment, it can be seen that the important word are set in the past because the importance is less than 5.

On the other hand, in a case in which the extracted important word is already present in the important word information (Y in step S260), the important word information update unit 153 sets the initial value of the importance of the important word in the comment to the importance of the important word (step S270). That is, the value of the importance is updated to the initial value regardless of the current value. In a case of the setting shown in FIG. 2, it is found that the “estimate” corresponds to this case.

As described above, in the present exemplary embodiment, the initial value of the important word is set for each of the document and the comment. Then, 3 is set as the initial value of the important word in the document, and 5 is set as the initial value of the important word in the comment. Each initial value may be set to the same value. However, in the present exemplary embodiment, the user refers to the content of the document and inputs the comment while considering the word to be used, so that it can be assumed that the user uses a word closely related to the content of the document, or an expression indicating a viewpoint of paying attention when confirming the content, the quality, or the error of the document in the comment. Therefore, in the present exemplary embodiment, the initial value is set to be higher in the comment than in the document. In addition, it is assumed that the content is more important as the comment is newer, so that the importance of the comment important word is subtracted. The word of which the comment importance becomes 0 as a result of the subtraction is not repeatedly input, and thus it is determined that the word does not correspond to the important word, and the word is temporarily deleted from the important word information. The initial values (3, 5) of the importance set for each of the document and the comment and the value (1) for subtracting the importance of the comment important word are merely examples, and appropriate values need only be set according to the type of the document and the like.

In the present exemplary embodiment, the important word information is created each time the document 21 that is the viewing target is displayed on the screen as described above, the comment is input, and the important word information of the document 21 is updated each time the trigger is input.

In the present exemplary embodiment, the important word information is created in step S120 shown in FIG. 3. However, unless the content of the document 21 is changed or unless the feature word extraction method is changed, the same feature word is extracted as the important word. Therefore, until such a change can be confirmed, the created important word information may be read from the important word information storage unit 17 and used without creating the important word information each time the document 21 is selected. This configuration also makes use of the content of the update to the important word information performed in step S160 shown in FIG. 3. Since the input comment is included in the comment information and stored in the comment information storage unit 18, the important word information shown in FIG. 5 can be reproduced even in a case in which the important word information is created each time the document 21 is selected.

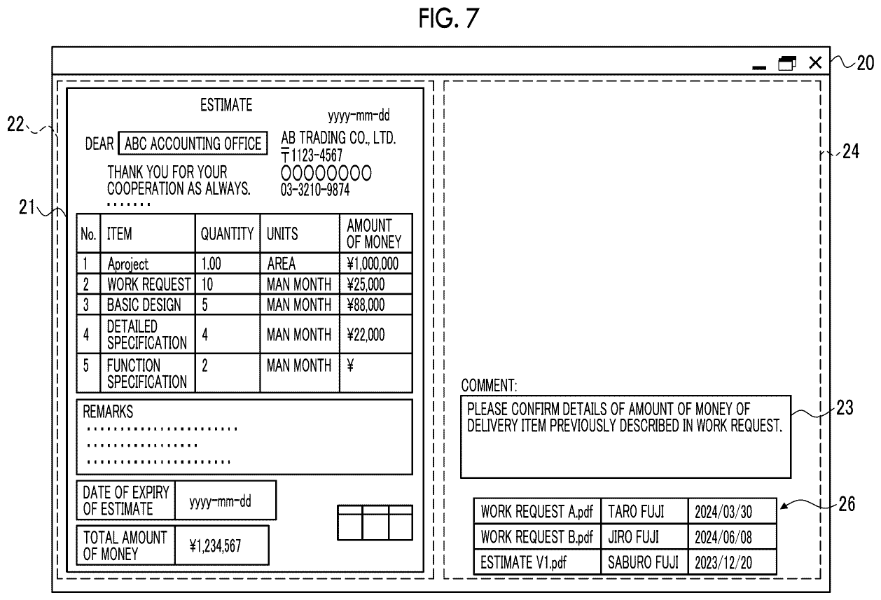

Returning to FIG. 3, in a case in which the comment is input by the user, and the update of the important word information performed in response to the input of the trigger ends, the search processing unit 14 subsequently searches for the related document using, as the keyword, the important word of the important word information (step S170). That is, the search processing unit 14 selects the related document of the document based on the important word extracted from the document and the comment from the document group of which information is managed by the document information storage unit 16. A screen display example of the window for document processing 20 for displaying an execution result of the search is shown in FIG. 7.

In the screen display example shown in FIG. 7, the comment input in the comment input field 23 and a related document list 26 showing a search result are added to the screen display example shown in FIG. 4. The related document list 26 corresponds to a related document display region in which the documents selected as the related documents by the search processing unit 14 are displayed in a list. In short, the search results by the search processing unit 14 are displayed in a list in the related document list 26.

As shown in FIG. 7, the information processing apparatus 10 updates the important word information in response to a period “.” included in the comment input by the user as the trigger, and executes the search processing based on the important word set in the updated important word information. The related document list 26 includes one or a plurality of related documents obtained as the search result. It goes without saying that there is also a possibility that the search result indicating that there is no document corresponding to the related document is obtained.

The recommended document presentation unit 154 includes and displays the information related to the related document selected by the search processing unit 14 in this way in the related document list 26. The information related to the related document includes at least the document name that is the identification information of the related document. FIG. 7 shows an example in which a creator and a creation date are displayed in association with the document name.

The related document included in the related document list 26 is, for example, a document in which a total value of the product of the number of words matching the important word included in the important word information and the importance of the important word is equal to or greater than a predetermined threshold value, among a plurality of documents (hereinafter, also referred to as a “document group”) of which information is managed by the document information storage unit 16. In addition, as an arrangement order, the related documents in the related document list 26 are, for example, arranged in descending order of the total value of the product of the number of the words and the importance of the important word.

The related document included in the related document list 26 is positioned as a related document to be presented to the user, more specifically, to the comment inputter, based on the document and the comment on the document by the information processing apparatus 10. It can also be said that the document is a document recommended by the information processing apparatus 10 as the related document to the comment inputter.

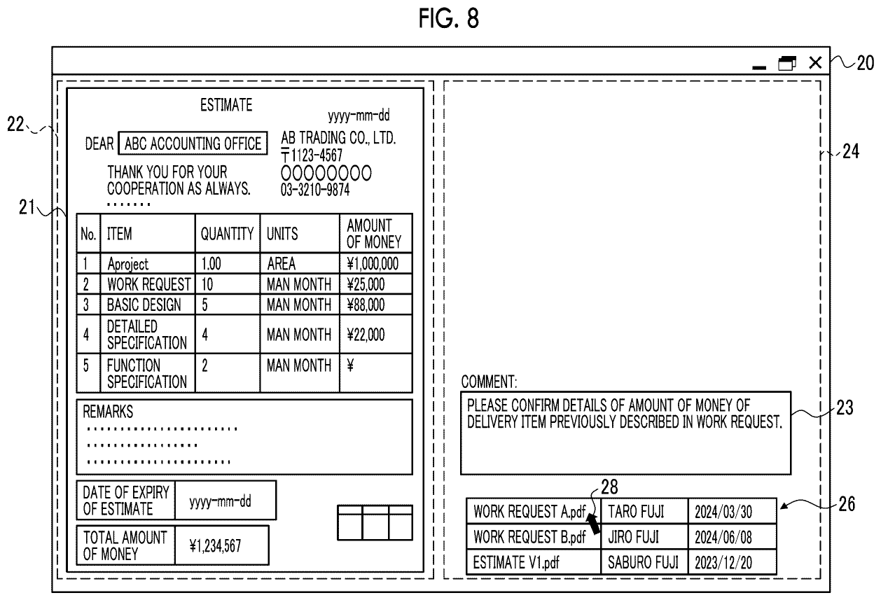

FIG. 8 is the same screen display example as FIG. 7, but FIG. 8 shows an example in a case in which the user selects the related document by a mouse operation. The user can confirm the selected related document by the position of a mouse cursor 28.

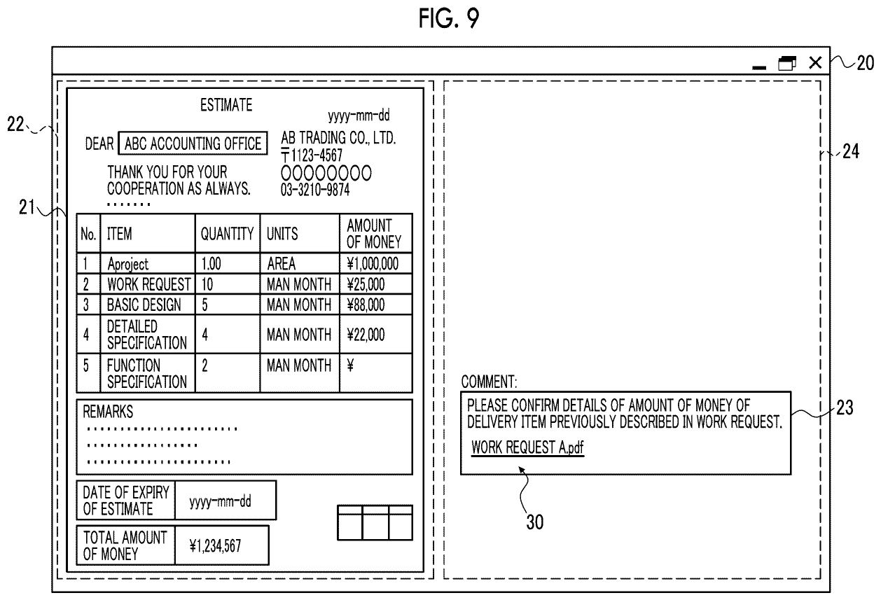

The user aligns the mouse cursor 28 with a row corresponding to the related document to be selected. As shown in FIG. 8, in a case in which the user selects the “work request A.pdf”, the recommended document presentation unit 154 displays information for specifying the selected related document in the comment input field 23 as shown in FIG. 9. In the present exemplary embodiment, the related document selected based on the comment is added to the input comment in this way.

In the present exemplary embodiment, a document name 30 of the related document is displayed as the information for specifying the related document. In addition, the recommended document presentation unit 154 sets storage destination link information in the document name 30. Therefore, the user can display the content of the document by clicking and selecting the document name 30. The user may select the plurality of related documents from the related document list 26.

The related document included in the related document list 26 is a related document presented to the user (comment inputter) by the information processing apparatus 10 as described above, and is positioned as a document recommended to the comment inputter. As a result, the user does not need to search for the related document of the document 21 being viewed.

On the other hand, the related document selected by the user, that is, the comment inputter from the related document list 26 is, for example, a document recommended to another user who views the document 21 being viewed by the comment inputter in the subsequent processing. The document extracted by the search based on the important word by the search processing unit 14 corresponds to the related document of the document 21 as described above, but, in the present exemplary embodiment, the related document selected for presentation to another user by the user from among the related documents is referred to as a “recommended document” in particular. The information processing apparatus 10 controls the related document (that is, the recommended document) selected by the user, to be viewable by another user.

In FIG. 9, the related document list 26 is no longer displayed in a case in which the user selects the recommended document. However, the related document list 26 need not be erased from the screen. In a case in which a display state of the related document list 26 is maintained, the related document selected as the recommended document may be deleted from the related document list 26. That is, after the user selects the recommended document, the related document list 26 shown in FIG. 8 is in a state in which “work request B.pdf” and “estimate V1.pdf” are left and displayed.

As described above, the related document including the recommended document is selected from the document group based on the document 21 and the important word included in the comment.

### Exemplary Embodiment 2

The configuration (FIG. 1) and the document processing (FIG. 3) of the information processing apparatus 10 in the present exemplary embodiment may be the same as the configuration and the document processing of Exemplary Embodiment 1. In the present exemplary embodiment, since the user interface for selecting the recommended document from among the related documents is different from the user interface in Exemplary Embodiment 1, the detailed processing content of presentation processing of the recommended document shown in FIG. 3 (step S180) is different from the detailed processing content in Exemplary Embodiment 1.

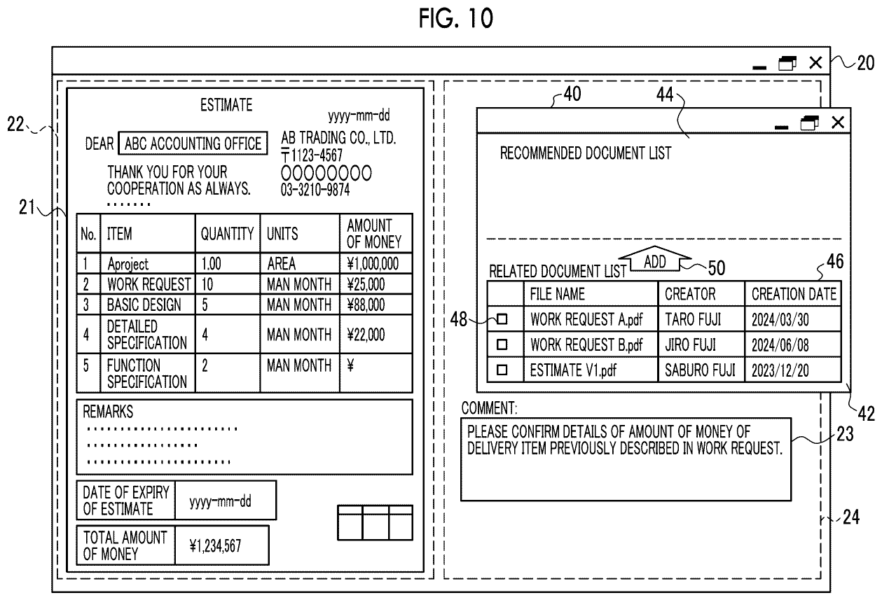

FIG. 10 is a diagram showing an example of screen display in a case in which a window for recommended document selection 40 for selecting the recommended document is superimposed and displayed on the window for document processing 20 shown in FIG. 4.

The window for recommended document selection 40 includes a related document list display region 42 provided at a lower portion of the window and a recommended document display region 44 provided at an upper portion of the window. The related document list 46 is displayed in the related document list display region 42. The related document list 46 according to the present exemplary embodiment is different from the related document list 26 shown in FIG. 7 in that a check box 48 is associated with each related document. An add button 50 is further displayed in the related document list display region 42. In an initial state of the window for recommended document selection 40, the recommended document is not displayed in the recommended document display region 44.

Hereinafter, an operation of the present exemplary embodiment will be described.

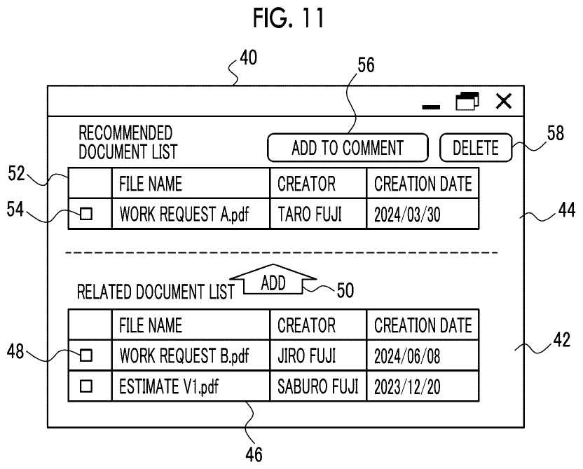

In the present exemplary embodiment, the processing up to the selection of the related document (steps S110 to S170) is the same as in Exemplary Embodiment 1. Thereafter, the recommended document presentation unit 154 executes processing of presenting the recommended document (step S180). The recommended document presentation unit 154 in the present exemplary embodiment displays the window for recommended document selection 40 as shown in FIG. 10, and displays the related document list 46 in the related document list display region 42. The user checks the check box 48 corresponding to the related document selected as the recommended document from among the related documents, and then performs a selection operation of the add button 50. FIG. 11 shows a screen display example of the window for recommended document selection 40 after the selection operation of the add button 50 is performed by the user. Since the display content of the window for document processing 20 is the same as the display content of the window for document processing 20 in FIG. 10, the illustration thereof is omitted.

FIG. 11 is an example of a display screen in a case in which the “work request A.pdf” is selected and then the selection operation of the add button 50 is performed. As shown in FIG. 11, a recommended document list 52 including the recommended documents selected by the user is displayed in the recommended document display region 44.

The recommended document list 52 is a selected document display region in which information related to the related document selected by the user from among the related documents displayed in the related document list 46 is moved and displayed in a list. The related document moved from the related document list 46 to the recommended document list 52 is deleted from the related document list 46. In a case in which the user selects the add button 50 after checking a plurality of check boxes 48 in the related document list 46, the user can move a plurality of related documents to the recommended document list 52 at the same time.

In a case of the present exemplary embodiment, the recommended document displayed in the recommended document list 52 is actually positioned as a candidate for the recommended document. Therefore, the user checks the check box 54 corresponding to one or a plurality of recommended documents to be presented to another user from among the candidates of the recommended documents displayed in the recommended document list 52, and then performs a selection operation of the add button 56 on the comment. The selection operation of the add button 56 on the comment is equivalent to a confirmation operation of confirming the candidates of the recommended documents for which the check is put in the check box 54 as the recommended documents.

Here, in a case in which the user selects the “work request A.pdf”, the recommended document presentation unit 154 displays the information for specifying the recommended document by including the information in the comment input field 23 as shown in FIG. 9 in response to the selection operation of the add button 56 on the comment. As described above, the recommended document can be added to the comment. Then, the recommended document presentation unit 154 deletes the “work request A.pdf” from the recommended document list 52. In a case in which the recommended document list 52 need not include one recommended document, the table of the recommended document list 52 need not be displayed.

Further, a delete button 58 is displayed in the recommended document display region 44. The user checks the check box 54 corresponding to one or a plurality of recommended documents for which the recommendation is to be canceled from among the candidates of the recommended documents displayed in the recommended document list 52, and then performs a selection operation of the delete button 58. The recommended document presentation unit 154 moves the recommended document from the recommended document list 52 to the related document list 46 in response to the selection operation of the delete button 58. That is, the selection operation of the delete button 58 is equivalent to a cancel operation of canceling the positioning of the recommended document, for which the check box 54 is checked, as the candidate for the related document and returning the recommended document to the related document list 46 as the related document.

According to the present exemplary embodiment, it is possible to easily select the recommended document from among the related documents or perform an operation for eliminating the status of the recommended document of the related document as a candidate for the recommended document.

In a case in which the related document is selected in response to the trigger input, the comment management unit 155 creates the comment information by associating the related document with the comment stored in the temporary storage unit 152, and registers the comment information in the comment information storage unit 18. Information of the recommended document selected from among the related documents and added to the comment is managed to be distinguished from the related document that is not selected (that is, the related document that is not the recommended document).

In Exemplary Embodiment 1, since the recommended document is determined as shown in FIG. 9, it is not assumed that information on the related document that is not selected as the recommended document is stored. That is, in a case in which the related document is selected in response to the trigger input, the comment management unit 155 simply creates the comment information by associating the recommended document with the comment stored in the temporary storage unit 152, and registers the comment information in the comment information storage unit 18. It goes without saying that, in Exemplary Embodiment 1, the information related to the selected related document may be temporarily included in the comment information and stored in the same manner as in the present exemplary embodiment.

### Exemplary Embodiment 3

The configuration (FIG. 1) and the document processing (FIG. 3) of the information processing apparatus 10 in the present exemplary embodiment may be the same as the configuration and the document processing of Exemplary Embodiment 1. In the present exemplary embodiment, the detailed processing content of the presentation processing of the recommended document shown in FIG. 3 (step S180) is different from the detailed processing content in Exemplary Embodiment 1.

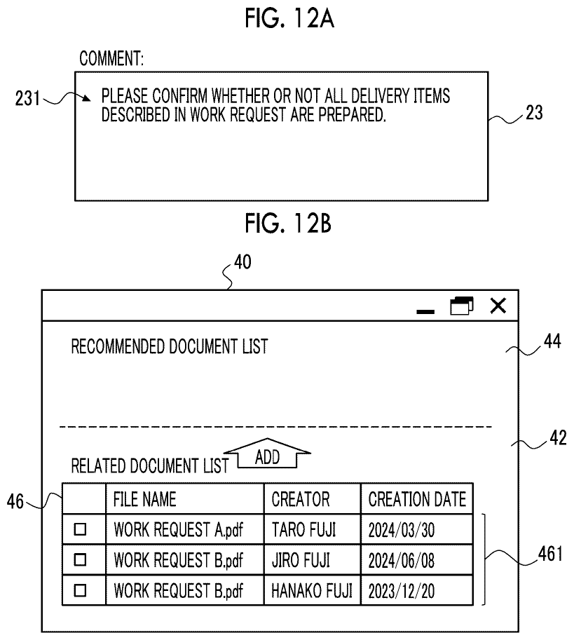

FIG. 12A is a diagram showing a comment 231 input to the comment input field 23. FIG. 12B is a diagram showing the window for recommended document selection 40 for displaying the related document list 46 including related documents 461 selected based on the comment 231. FIGS. 12A and 12B show a relationship between the comment 231 input to the comment input field 23 and a plurality of related documents (hereinafter, also referred to as a “related document group”) 461 displayed in the related document list 46 based on the comment 231. The window for document processing 20 may be the same as the window for document processing 20 shown in FIG. 4 except for the display content in the comment input field 23, and thus the illustration is omitted.

As described above, the configuration in which the comment 231 is input to the comment input field 23 and the related document is displayed in the related document list 46 in a case in which the predetermined trigger is input is as described above, and is as shown in FIGS. 12A and 12B. The arrangement of the related document group 461 displayed in the related document list 46 in FIG. 12B is determined with reference to the importance, as described in Exemplary Embodiment 1.

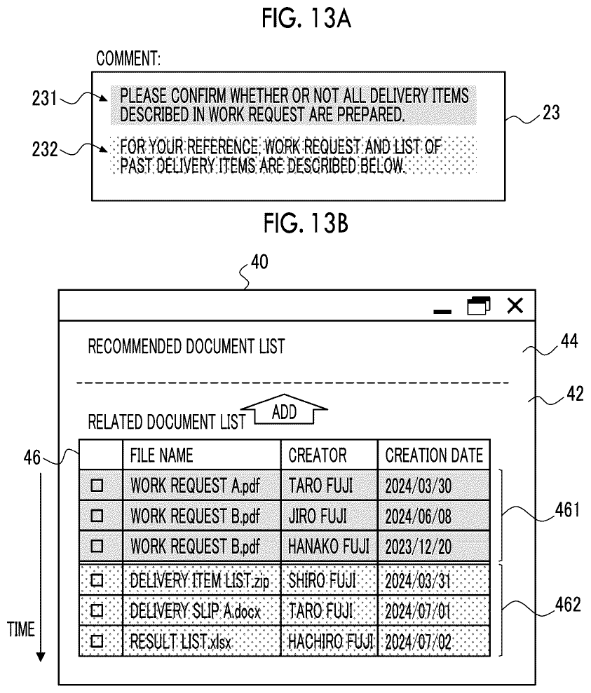

FIGS. 13A and 13B are diagrams showing a state in which a comment 232 and the trigger are further input from the display state shown in FIGS. 12A and 12B. FIG. 13A shows that the comment 232 is further input to the comment input field 23 following the comment 231. FIG. 13B is a diagram showing the window for recommended document selection 40 for displaying the related document list 46 including the related documents selected based on the comments 231 and 232.

As described with reference to FIGS. 12A and 12B, in a case in which the comment 231 is input to the comment input field 23 and the predetermined trigger is input, the related document selected based on the comment 231 is displayed in the related document list 46.

In addition, as shown in FIG. 13A, in a case in which a new comment 232 is input following the comment 231, a related document group 462 selected based on the comment 232 is displayed in the related document list 46 in a case in which the predetermined trigger is input. The related document group 462 is displayed following the related document group 461.

In the present exemplary embodiment, each time the user newly inputs the comment (strictly speaking, each time the comment and the trigger are input), the related document is selected with reference to the comment of the newly input portion, and the selected related document is displayed in the related document list 46. The comment information created for each comment includes time information for specifying the input date and time of the comment, so that the recommended document presentation unit 154 refers to the time information and displays the related document groups 461 and 462 in the related document list 46 in the input order of the comments 231 and 232.

In the present exemplary embodiment, the comment newly input by the user and the identification information (in the present exemplary embodiment, the document name) of the related document selected with reference to the comment are displayed in association with each other. As shown in FIGS. 13A and 13B, in the present exemplary embodiment, the comment 231 and the related document group 461, and the comment 232 and the related document group 462 are displayed in a display form in which a correspondence relationship between the comment 231 and the related document group 461 and the comment 232 and the related document group 462 is visually recognized. In the display example shown in FIGS. 13A and 13B, the same background color is added to the comment 231 and the related document group 461. Further, the same pattern is added to the comment 232 and the related document group 462. The display form shown in FIGS. 13A and 13B used for associating the comment with the related document group is merely an example, and the comment may be associated with the related document group by another display form.

The arrangement of the related document group 462 newly displayed in the related document list 46 is determined with reference to the importance, as described in Exemplary Embodiment 1.

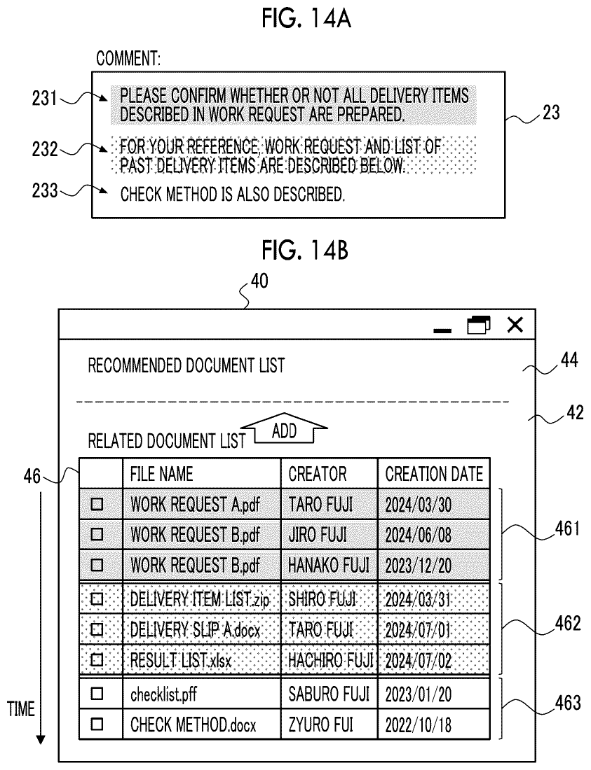

FIGS. 14A and 14B are diagrams showing a state in which a comment 233 and the trigger are further input from the display state shown in FIGS. 13A and 13B. FIG. 14A shows that the comment 233 is further input to the comment input field 23 following the comments 231 and 232. FIG. 14B is a diagram showing the window for recommended document selection 40 for displaying the related document list 46 including the related documents selected based on the comments 231, 232, and 233.

Since processing executed in a case in which the comment 233 is newly input is the same as the processing executed in a case in which the comment 232 is input, the duplicate description will be omitted. As is clear from FIGS. 14A and 14B, the comments 231, 232, and 234 and the related document groups 461, 462, and 463 are displayed in a display form in which the respective correspondence relationship is understood.

### Exemplary Embodiment 4

As described in Exemplary Embodiment 1, the related document is selected as a result of the search processing executed by using, as the keyword, the important word extracted from each of the document and the comment. However, a case in which the related document is not selected, or a case in which the related document expected by the user is not selected even in a case in which the related document is selected may be assumed. One of the causes is considered to be that an appropriate important word cannot be extracted from the viewing document.

Therefore, in the present exemplary embodiment, a function of allowing the user to designate the important word to be extracted from the viewing document is provided.

The configuration (FIG. 1) and a basic processing flow of the document processing (FIG. 3) of the information processing apparatus 10 in the present exemplary embodiment may be the same as the configuration and abasic processing flow of the document processing of Exemplary Embodiment 1. In the present exemplary embodiment, the detailed processing contents of the search processing (step S170) and the recommended document presentation processing (step S180) shown in FIG. 3 are different from the detailed processing contents in Exemplary Embodiment 1.

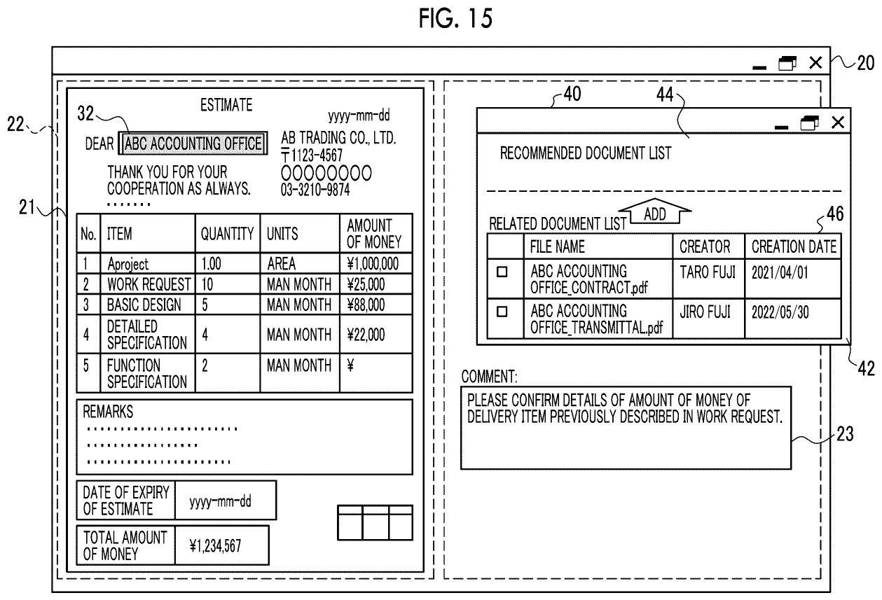

FIG. 15 is a diagram showing an example of screen display of the window for recommended document selection 40 in the present exemplary embodiment. In FIG. 15, the window for recommended document selection 40 is superimposed and displayed on the window for document processing 20, as in FIG. 10 in Exemplary Embodiment 2.

For example, it is assumed that, in a case in which the information processing apparatus 10 executes the search processing (step S170) to select the related document as in Exemplary Embodiment 1, the related document is not selected. In this case, the related document list 46 is not displayed in the related document list display region 42 on the initial screen of the window for recommended document selection 40.

Therefore, in the present exemplary embodiment, the user can designate a word to be set as the important word from the viewing document 21 displayed in the document display region 22. FIG. 15 shows an example of a case in which the words 32 “ABC accounting office” are selected as the important words by the user.

In a case in which the user selects a word to be the important word from the viewing document 21, the important word information creation unit 13 adds the word selected by the user as the important word to the important word information in response to the selection operation performed by the user. The comment input/output control unit 15 updates the important word information based on the input comment. The search processing unit 14 selects the related document by executing the search based on the important word included in the important word information. The search result obtained as described above, that is, the related document list 46 including the related document shown in FIG. 15 is displayed. Referring to the related document list 46 shown in FIG. 15, it can be seen that the two related documents are newly selected in response to the user selecting the words 32 “ABC accounting office”.

As in this example, in the present exemplary embodiment, the words 32 “ABC accounting office” selected by the user from the viewing document 21 are received as the feature words (that is, “important words”) of the viewing document 21. Then, the related document related to the viewing document 21 is selected with reference to the important word selected from the viewing document 21 by the user in addition to the important word automatically extracted from the viewing document 21 by the important word information creation unit 13 and the important word extracted from the comment on the viewing document 21 by the important word information update unit 153.

According to the present exemplary embodiment, it is possible to present the related document to the user by taking the important word designated by the user into account.

In the above description, the description has been made by assuming a case in which the word selected from the viewing document 21 by the user is the important word that is not included in the important word information. However, a case is also considered in which the word selected by the user is already included in the important word information. In this case, since the importance of the existing important word is increased, there is a possibility that a related document different from the initial related document or a new related document is selected.

### Exemplary Embodiment 5

In each of the above-described exemplary embodiments, the description has been made by assuming a case in which the comment input field 23 is provided in the comment display region 24 and the user inputs the comment to the comment input field 23 to add the comment on the viewing document 21. However, in the related art, there has been a document application that can add the comment by designating the text string included in the viewing document 21, instead of the viewing document 21. The present exemplary embodiment corresponds to a case in which the user designates the text string in the viewing document 21 and adds the comment.

The configuration (FIG. 1) and the document processing (FIG. 3) of the information processing apparatus 10 in the present exemplary embodiment may be the same as the configuration and the document processing of Exemplary Embodiment 1. The present exemplary embodiment is different from Exemplary Embodiment 1 in that the word designated by the user is acquired together in a case of receiving the comment input by the user (step S140).

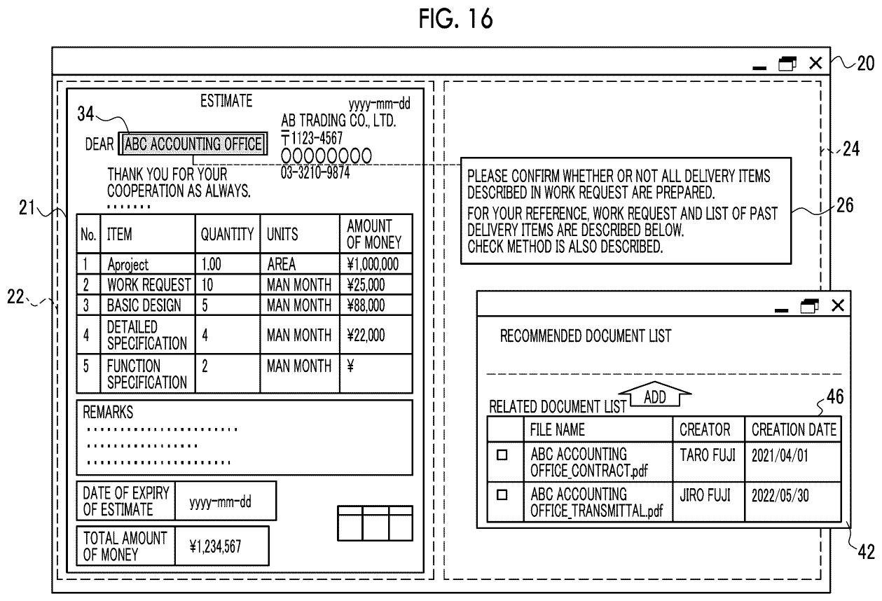

FIG. 16 shows an example of screen display of the window for document processing 20 and the window for recommended document selection 40 in the present exemplary embodiment. Before the user inputs the comment, the user designates a word that is the target to which the comment is added, from the viewing document 21. FIG. 16 shows an example of a case in which words 34 “ABC accounting office” are designated as the target to which the comment is added by the user. In a case in which the user designates the words 34 “ABC accounting office”, the comment input/output control unit 15 displays the comment input field 25 in the comment display region 24 in correspondence with the word 34. The user inputs the comment in the comment input field 25.

In the present exemplary embodiment, in a case in which the user designates any of the words 34 included in the viewing document 21 as described above and inputs the comment in association with the word 34, the word designated by the user is recognized as the important word in the viewing document 21 and is registered in the important word information. In Exemplary Embodiment 4, the user explicitly designates the important word, but, in the present exemplary embodiment, the word to which the comment is added is recognized as the important word.

According to the present exemplary embodiment, it is possible to select the related document related to the viewing document 21 by referring to the word 34 designated by the user as a comment addition target as the important word in addition to the important word automatically extracted from each of the viewing document 21 and the comment.

### Exemplary Embodiment 6

In each of the above-described exemplary embodiments, the related documents selected based on the important word information are displayed in a list in the related document lists 26 and 46. As shown in FIGS. 7 and 10, the related document lists 26 and 46 display the document name and the like as the information related to the related document. That is, the user has to determine whether or not to recommend the related document to another user without referring to the content of the document. Therefore, in the present exemplary embodiment, the content of the related document can be displayed. The function provided in the present exemplary embodiment is positioned as an additional function with respect to each of the above-described exemplary embodiments.

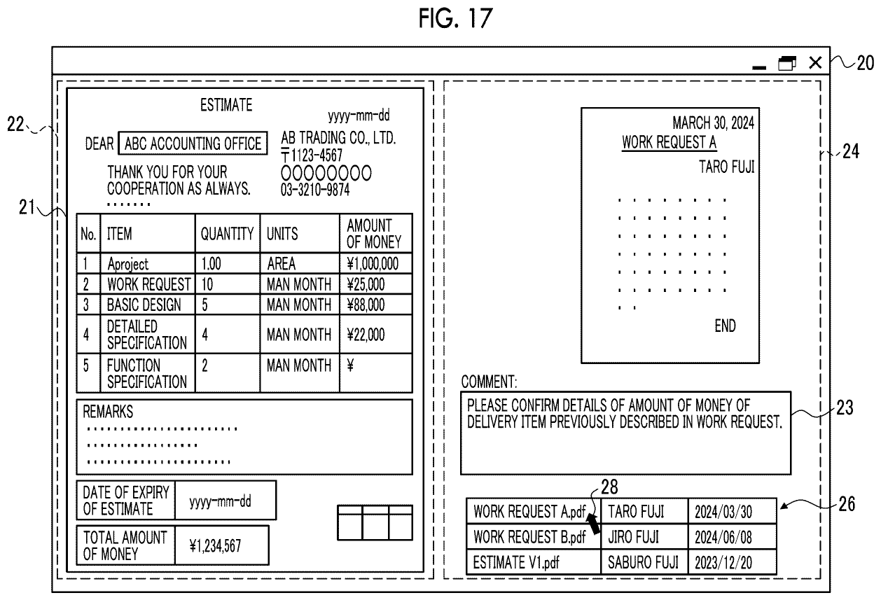

FIG. 17 is a diagram showing an example of screen display of the window for document processing 20 in the present exemplary embodiment. The display content is the same as the display content in FIG. 7 in Exemplary Embodiment 1.

The user performs a predetermined operation on the document name of the related document of which the document content is to be displayed and confirmed, from among the related documents displayed in the related document list 26. In the present exemplary embodiment, a mouse over is assumed as the predetermined operation, but the predetermined operation may be another operation.

In a case in which the user moves the mouse cursor 28 over the “work request A.pdf” as shown in FIG. 17, the comment input/output control unit 15 detects that the user selects the related document “work request A.pdf”. The mouse over is not limited to being performed at the position of the document name, and may be performed at any position of the entire row for displaying the information related to the related document.

In a case in which the mouse over is detected, the comment input/output control unit 15 acquires the storage destination information of the related document from the document information storage unit 16, acquires the document data from the storage destination specified from the storage destination information, and displays the document data on the screen. In FIG. 17, it is shown that the content of the document is displayed in the comment display region 24, but the present invention is not limited to this, and a window including a display region for displaying the content of the document may be separately generated and may be displayed at any place on the screen.

### Exemplary Embodiment 7

In each of the above-described exemplary embodiments, the function of presenting the related document of the document displayed on the screen by executing the document application to the user is provided. In the present exemplary embodiment, the related document can be presented even in a case in which a mailer is used. More specifically, a function of attaching the related document to the reply email to the received email is provided.

The configuration (FIG. 1) and the document processing (FIG. 3) of the information processing apparatus 10 in the present exemplary embodiment may be basically the same as the configuration and the document processing of Exemplary Embodiment 1. However, the document processing unit 12 in Exemplary Embodiment 1 exhibits the function provided by the document application, but has, in the present exemplary embodiment, a function provided by an application for processing an email as the document, that is, a mailer.

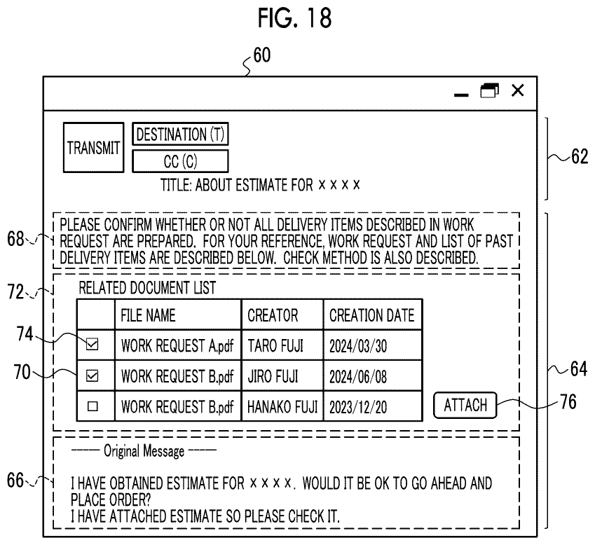

FIG. 18 is a diagram showing an example of a reply email screen 60 displayed in a window displayed by the mailer according to the present exemplary embodiment. The reply email screen 60 can be divided into a display region 62 in which a header portion is displayed and a display region 64 in which a content other than the header portion, such as a body, is displayed. The display region 64 other than the header portion includes a display region 66 of the body described in the received email, an input region 68 in which the reply message is input by the user, and a display region 72 for presenting the related document list 70 to the user.

In the present exemplary embodiment, a received email body included in the display region 66 of the reply email screen 60 corresponds to the document in each of the above-described exemplary embodiments. The input region 68 corresponds to the comment input field 23 in each of the above-described exemplary embodiments. The reply message included in the input region 68 corresponds to the body in the reply email and corresponds to the comment in each of the above-described exemplary embodiments. The related document list 70 is, for example, the same as the related document list 46 shown in FIG. 12B.

The information processing apparatus 10 according to the present exemplary embodiment displays the reply email screen 60 shown in FIG. 18 in a case of creating the reply email to the received email. In this case, the important word information creation unit 13 creates the important word information in the received email body. In addition, the important word information update unit 153 updates the important word information with reference to the reply message. The search processing unit 14 searches for the related document using, as the keyword, the important word of the important word information, and selects the related document as the search result. The recommended document presentation unit 154 creates the related document list 70 shown in FIG. 18 and displays the related document list 70 in the display region 72.

The mailer operates instead of the document application, and the screen layout for displaying the document and the related document list is different, but in the present exemplary embodiment, the related document to the received email body can be presented to the user who is the email sender by executing the same processing as the processing in each of the above-described exemplary embodiments.

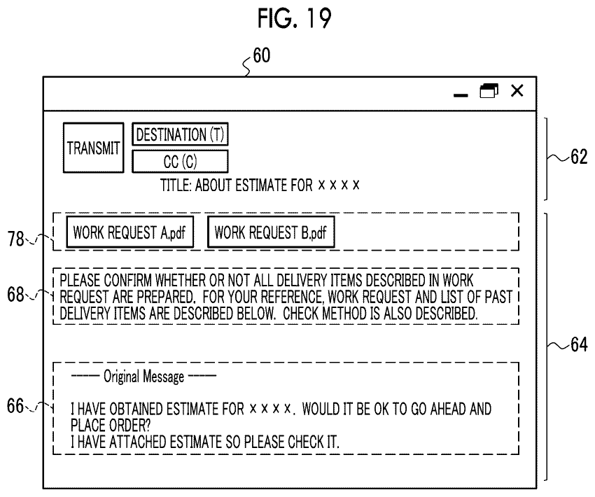

Here, in a case in which the user performs an operation of checking the check box 74 corresponding to the related document to be attached to the reply email and selecting an attach button 76, the comment input/output control unit 15 adds the related document selected by the user, that is, “work request A.pdf” and “work request B.pdf” in the example shown in FIG. 18, to the reply email as the attached document. The selection of the related document to be attached here corresponds to the selection of the recommended document from among the related documents in the above-described exemplary embodiments. FIG. 19 shows a display example of the reply email screen 60 in a state in which the attached document is added.

As shown in FIG. 19, it can be seen that the related document selected by the user is attached to an attached document display region 78 included in the display region 64. This fact is equivalent to the fact that the related document (that is, the recommended document) is added to the comment (that is, the reply message in the present exemplary embodiment) in the above-described exemplary embodiments.

In FIG. 19, by attaching the related document, the display region 72 for presenting the related document list 70 shown in FIG. 18 to the user is deleted. This processing corresponds to the processing of deleting the related document list 26 as shown in FIG. 9 in Exemplary Embodiment 1.

In the present exemplary embodiment, since the reply email is described as an example, the related document is presented to a sender of the received email, that is, an email creator. However, by setting the destination to a person other than the sender of the email and making the email a forwarded email, it is possible to present the email to another user in each of the above-described exemplary embodiments.

The above-described exemplary embodiments may be combined as appropriate with other exemplary embodiments as necessary.

In the present exemplary embodiment, each processing is executed by any computer.

In addition, any computer may execute the processing by the processor as hardware, the program as software, or a combination thereof. In such a case, the processor is configured to execute various types of processing in the present exemplary embodiment in cooperation with the program, and may function as each unit or each means in the present exemplary embodiment.

Further, an execution order of the processing executed by the processor is not limited to the order described, and may be changed as appropriate. The computer may be a general-purpose computer, a computer for a specific application, a workstation, or another system capable of executing each processing.

The processor may be configured by one or a plurality of pieces of hardware, and the types of hardware are not limited. In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. The hardware is configured by an electric circuit (circuitry) in which circuit elements, such as semiconductor elements, are combined.

Further, the program may be software such as firmware or microcode. In addition, the program may be, for example, a program module group, and each function thereof may be implemented by a processor configured to execute each function. The program may be a program code or a plurality of code segments stored in one or a plurality of non-transitory computer-readable media (for example, storage media or other storages). The program may be stored in a plurality of non-transitory computer-readable media present in physically separated devices. The program code or the code segment may represent any combination of a procedure, a function, a sub-program, a routine, a sub-routine, a module, a software package, a class, or an instruction, a data structure, or a program statement. The program code or the code segment may be connected to another code segment or a hardware circuit by transmitting and receiving information, data, an argument, a parameter, or a content of a memory.

The present invention can also be applied to a program and a program product.

### Supplementary Note

(((1)))

An information processing system comprising:
a processor configured to:
   receive a comment input by a user on a document;
   select a related document based on the document and the comment; and present the selected related document.
      (((2)))

The information processing system according to (((1))), wherein the processor is configured to:
in a case in which a plurality of related documents are selected, display pieces of identification information of the plurality of selected related documents in a list in a related document display region; and
control a related document corresponding to identification information selected by the user from the displayed list, to be viewable by another user.
   (((3)))

The information processing system according to (((2))), wherein the processor is configured to:
include the identification information of the related document controlled to be viewable, in an input region of the comment input by the user.
   (((4)))

The information processing system according to (((2))), wherein the processor is configured to:
move identification information of the related document selected by the user from among the pieces of identification information of the related documents displayed in the list in the related document display region to a selected document display region from the related document display region, to display the identification information in the selected document display region, and
in response to a confirmation operation performed by the user, include the identification information of the related document displayed in the selected document display region, in an input region of the comment input by the user.
   (((5)))

The information processing system according to (((4))), wherein the processor is configured to:
in response to a cancel operation performed by the user, return the identification information of the related document moved to the selected document display region, to the related document display region.
   (((6)))

The information processing system according to any one of (((1))) to (((5))), wherein the processor is configured to:
each time a comment is newly input by the user, select the related document with reference to the comment of a newly input portion.
   (((7)))

The information processing system according to (((6))), wherein the processor is configured to:
display the comment newly input by the user in association with identification information of the related document selected with reference to the comment.
   (((8)))

The information processing system according to any one of (((1))) to (((7))), wherein the processor is configured to:
in response to a predetermined user operation on identification information of the presented related document, display a content of the related document corresponding to the identification information.
   (((9)))

The information processing system according to (((8))), wherein the processor is configured to:
display a feature word included in at least one of a displayed document or related document, to be distinguishable from other words.
   (((10)))

The information processing system according to any one of (((1))) to (((9))), wherein the processor is configured to:
receive a word selected by the user from the document as a feature word of the document; and
select the related document related to the document with reference to the received feature word in addition to an extracted feature word of each of the document and the comment.
   (((11)))

The information processing system according to any one of (((1))) to (((10))), wherein the processor is configured to:
in a case in which the user designates a word included in the document and inputs a comment in association with the word, receive the word designated by the user as a feature word of the document; and
select the related document related to the document with reference to the received feature word in addition to an extracted feature word of each of the document and the comment.
   (((12)))

The information processing system according to any one of (((1))) to (((11))), wherein the processor is configured to:
in a case in which a body of a received email is treated as the document and a body of a reply email or a forwarded email to the email is treated as the comment, present the selected related document by including the selected related document in the body of the reply email or the forwarded email.
   (((13)))

The information processing system according to (((12))), wherein the processor is configured to:
attach the related document selected by the user from among the related documents included in the body of the reply email or the forwarded email, to the reply email or the forwarded email.
   (((14)))

A program causing a computer to implement:
a function of receiving a comment input by a user on a document;
a function of selecting a related document based on the document and the comment; and
a function of presenting the selected related document.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
receive a comment input by a user on a document;
select a related document based on the document and the comment; and
present the selected related document.

2. The information processing system according to claim 1, wherein the processor is configured to:
in a case in which a plurality of related documents are selected, display pieces of identification information of the plurality of selected related documents in a list in a related document display region; and
control a related document corresponding to identification information selected by the user from the displayed list, to be viewable by another user.

3. The information processing system according to claim 2, wherein the processor is configured to:
include the identification information of the related document controlled to be viewable, in an input region of the comment input by the user.

4. The information processing system according to claim 2, wherein the processor is configured to:
move identification information of the related document selected by the user from among the pieces of identification information of the related documents displayed in the list in the related document display region to a selected document display region from the related document display region, to display the identification information in the selected document display region, and
in response to a confirmation operation performed by the user, include the identification information of the related document displayed in the selected document display region, in an input region of the comment input by the user.

5. The information processing system according to claim 4, wherein the processor is configured to:
in response to a cancel operation performed by the user, return the identification information of the related document moved to the selected document display region, to the related document display region.

6. The information processing system according to claim 1, wherein the processor is configured to:
each time a comment is newly input by the user, select the related document with reference to the comment of a newly input portion.

7. The information processing system according to claim 6, wherein the processor is configured to:
display the comment newly input by the user in association with identification information of the related document selected with reference to the comment.

8. The information processing system according to claim 1, wherein the processor is configured to:
in response to a predetermined user operation on identification information of the presented related document, display a content of the related document corresponding to the identification information.

9. The information processing system according to claim 8, wherein the processor is configured to:
display a feature word included in at least one of a displayed document or related document, to be distinguishable from other words.

10. The information processing system according to claim 1, wherein the processor is configured to:
receive a word selected by the user from the document as a feature word of the document; and
select the related document related to the document with reference to the received feature word in addition to an extracted feature word of each of the document and the comment.

11. The information processing system according to claim 1, wherein the processor is configured to:
in a case in which the user designates a word included in the document and inputs a comment in association with the word, receive the word designated by the user as a feature word of the document; and
select the related document related to the document with reference to the received feature word in addition to an extracted feature word of each of the document and the comment.

12. The information processing system according to claim 1, wherein the processor is configured to:
in a case in which a body of a received email is treated as the document and a body of a reply email or a forwarded email to the email is treated as the comment, present the selected related document by including the selected related document in the body of the reply email or the forwarded email.

13. The information processing system according to claim 12, wherein the processor is configured to:
attach the related document selected by the user from among the related documents included in the body of the reply email or the forwarded email, to the reply email or the forwarded email.

14. A non-transitory computer readable medium storing a program causing a computer to implement:
a function of receiving a comment input by a user on a document;
a function of selecting a related document based on the document and the comment; and
a function of presenting the selected related document.

15. An information processing method comprising:
receiving a comment input by a user on a document;
selecting a related document based on the document and the comment; and
presenting the selected related document.
